(19) United States
(12) Patent Application Publication
(10) Pub. No.: US 2005/0283359 A1
(43) Pub. Date: Dec. 22, 2005

(54) MULTI-LANGUAGE SYSTEM CONTAINING A LANGUAGE INFORMATION MODULE AND RELATED METHOD CAPABLE OF UPDATING LANGUAGE INFORMATION

(76) Inventors: Tsung-I Lin, Taipei Hsien (TW); Yu-Chuan Yang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 10/711,817

(22) Filed: Oct. 7, 2004

(30) Foreign Application Priority Data
Jun. 18, 2004 (TW) 093117817

(51) Int. Cl. G06F 17/20

(52) U.S. Cl. 704/8

(57) ABSTRACT

A multi-language system containing a language information module and a related method capable of updating language information are provided. The multi-language system includes an interface module utilized for generating a user interface; a language information module containing at least one identification string and at least one language information set, each identification string corresponding to a language information set, and each language information set representing a natural language; and a font database containing at least one font set, each font set corresponding to a language information set and containing at least one font file for representing the natural language corresponding to the language information set; wherein according to the language information set stored in the language information module, the interface module is utilized for reading the font set corresponding to the natural language which corresponds to the language information set to select and display the font file(s) on the user interface.

### BACKGROUND

The present invention relates to a multi-language system and a related method, and more specifically, to a multi-language system containing a language information module and a related method capable of updating language information.

As the globalization era arrives and products are more and more internationalized, a Man-Machine Interface (MMI) only supporting a single natural language does not meet users' needs. When a user purchases products, such as a mobile phone, the available functions are one of the main concerns for the user. Besides, the MMI design of the mobile phone is an important factor in the user's concern. Generally speaking, users all expect a multi-language interface installed on the mobile phone. Hence, most mobile phones in the present business market contain multi-language systems to support displaying various natural languages.

Please refer to FIG. 1. FIG. 1 is a functional block diagram of a multi-language system 10 according to the related art. The multi-language system 10 comprises a microprocessor 16, an interface module 12 and a font database 28. The interface module 12 is stored in a storage device 18 wherein the interface module 12 could be a Man-Machine Interface (MMI) software utilized for generating a MMI between a user and a hardware device. The MMI is a user interface. The interface module 12 comprises a plurality of language information sets 24. Each language information set 24 represents a natural language and is stored in the interface module 12 by setting parameters. The above-mentioned parameters contain the related information for the natural language. The font database 28 is stored in a storage device 14. The font database 28 comprises a plurality of font sets 22. Each font set 22 corresponds to a language information set 24 and comprises at least one font file (a bitmap image file corresponding to a character) for representing a natural language corresponding to the language information set 24. For example, a first font set contains font files of characters of Traditional Chinese, and a second font set contains font files of characters of English. Besides, the microprocessor 16 is electrically connected to the storage device 14 and the storage device 18.

The interface module 12 needs to provide a user interface supporting various natural languages, which means to provide a user interface on which strings of various natural languages can be displayed, for example, displaying strings [symbol] [symbol] and “English” on the user interface. The interface module 12 must read the language information set 24 corresponding to TraditionaI Chinese and finds font files (bitmap image files) of characters [symbol] t and [symbol] in a font set 22 corresponding to Traditional Chinese in the font database 28. In the same manner, the interface module 12 reads the language information set 24 corresponding to Simplified Chinese and finds font files of the characters [symbol] and [symbol] in a font set 22 corresponding to Simplified Chinese in the font data base 28. The interface module 12 reads the language information set 24 corresponding to English and finds font files of the characters “E”, “n”, “g”, “l”, “i”, “s”, “h” and “h” in a font set 22 corresponding to English in the font database 28. Afterwards, the strings [symbol] [symbol] and “English” are displayed on the user interface. Please refer to FIG. 2. FIG. 2 is a flowchart describing the steps for displaying font files of natural languages on the user interface with the multi-language system 10. The displayed strings [symbol] [symbol] and “English” are given as examples for describing the steps for displaying font files of natural languages with the multi-language system 10. The steps are:

Step 100: Start;

Step 102: The microprocessor 16 executes the interface module 12;

Step 104: The interface module 12 reads the language information set 24 corresponding to Traditional Chinese and finds font files (bitmap image files) of characters [symbol] and [symbol] in a font set 22 corresponding to Traditional Chinese in the font database 28. In the same manner, the interface module 12 reads the language information set 24 corresponding to Simplified Chinese and finds font files of the characters [symbol] and [symbol] in a font set 22 corresponding to Simplified Chinese. The interface module 12 reads the language information set 24 corresponding to English and finds font files of the characters “E“, “n”, “g”, “l”, “i”, “s” and “h” in a font set 22 corresponding to English;

Step 106: Display the strings [symbol] [symbol] and “English” on the user interface; and

Step 108: End.

When a user turns on a mobile phone, the multi-language system 10 starts operating (step 100). Next, the microprocessor 16 loads the interface module 12 and executes it (step 102). Because the interface module 12 contains all language information sets 24, the interface module 12 knows the natural languages supported in the multi-language system 10. In the embodiment according to the related art, the multi-language system 10 supports Traditional Chinese, Simplified Chinese and English. Hence, the interface module 12 must display strings [symbol] [symbol] and “English” on the user interface to let users know the natural languages supported in the mobile phones (the multi-language system 10).

Afterwards, in the step 104, the interface module 12 reads the language information set 24 corresponding to Traditional Chinese and finds font files (bitmap image files) of characters [symbol] and [symbol] in a font set 22 corresponding to Traditional Chinese in the font database 28. In the same manner, the interface module 12 reads the language information set 24 corresponding to Simplified Chinese and finds font files of the characters [symbol] and [symbol] in a font set 22 corresponding to Simplified Chinese in the font database 28. The interface module 12 reads the language information set 24 corresponding to English and finds font files of the characters “E”, “n”, “g”, “l”, “i”, “s” and “h” in a font set 22 corresponding to English in the font data base 28. In the step 106, the interface module 12 displays strings [symbol] [symbol] and “English” on the user interface.

The multi-language system 10 applied in a mobile phone is given as an example. The mobile phone executes the interface module 12 to provide a user interface to operate the mobile phone. If a manufacturer wants to sell the mobile phone in a specific area, the manufacturer must provide a multi-language interface installed in the mobile phone where the multi-language interface meets the needs of users of the specific area. Assuming the manufacturer wants to sell the mobile phone in a Chinese area, it is necessary to make sure that strings of English, Simplified Chinese and Traditional Chinese can be displayed on the user interface of the mobile phone to provide a multi-language environment in which English, Traditional Chinese and Simplified Chinese are supported. When a manufacturer wants to sell the mobile phone in Japan, it is necessary to provide a user interface which simultaneously supports English and Japanese.

As mentioned above, the interface module 12 knows the natural languages supported in the multi-language system 10 according to the language information sets 24. Therefore, if the manufacturer wants to modify (eg: add or delete) a natural language supported in the mobile phone, the manufacturer needs to insert or delete font set(s) 22 corresponding to the natural language into or from the font database 28. In addition, it is necessary to insert or delete a language information set 24 corresponding to the natural language, which means it is necessary to modify the interface module 12. For example, when the manufacturer wants to make the multi-language system 10 of the mobile phone display Thai, the manufacturer must insert font set(s) 22 corresponding to Thai into the font database 28 stored in the storage device 14 and insert a language information set 24 corresponding to Thai into the interface module 12. If the manufacturer does not want to make the multi-language system 10 display Simplified Chinese, the manufacturer must delete the font set(s) 22 corresponding to Simplified Chinese from the font database 28 stored in the storage device 14 and delete a language information set 24 corresponding to Simplified Chinese in the interface module 12. Hence, it is unavoidable to modify the interface module 12.

The interface module 12 is a piece of program code executable by the microprocessor 16. Generally speaking, the interface module 12 is a piece of source code, which is compiled to generate a piece of binary code. The language information set(s) 24 can be seen as parameter settings stored in the interface module 12. Therefore, as mentioned above, if a manufacturer wants to insert or delete a specific natural language into or from the multi-language system 10 according to the related art, the source code of the interface module 12 must be modified for inserting or deleting a language information set 24 corresponding to the specific natural language (modifying the related parameters and the corresponding function settings). Afterwards, the modified source code is compiled for generating the needed interface module 12. Therefore, it is a user-inconvenient design product. Whenever a mobile phone manufacturer wants to sell mobile phones in different areas, it is necessary to modify the interface module 12 to meet users' needs, resulting in higher production cost of mobile phones and worse competitiveness in the market.

### SUMMARY

It is therefore an objective of the claimed invention to provide a multi-language system containing a language information module and a related method capable of updating language information to solve the above-mentioned problem.

According to the claimed invention, a multi-language system containing a language information module is disclosed. The multi-language system contains: an interface module utilized for generating a user interface; a language information module comprising at least one identification string and at least one language information set, each identification string corresponding to a language information set, and each language information set representing a natural language; and a font database containing at least one font set, each font set corresponding to a language information set and containing at least one font file for representing the natural language corresponding to the language information set; wherein according to the language information set stored in the language information module, the interface module is utilized for reading the font set corresponding to the natural language which corresponds to the language information set to select and display the font file(s) on the user interface.

According to the claimed invention, a method is disclosed for inserting or deleting a specific natural language into or from the multi-language system. The method contains: inserting or deleting an identification string and a language information set corresponding to the specific natural language into or from the language information module, and inserting or deleting the font set(s) corresponding to the specific natural language into or from the font database.

In the multi-language system according to the claimed invention, the language information module and the interface module are independent, so products using the multi-language system are easily customized, which means when a manufacturer produces the products, a specific natural language can be inserted or deleted into or from the products according to market needs, which means inserting, deleting, or modifying a language information set and font set(s) corresponding to a natural language into or from the products. Therefore, the products of different natural languages can be quickly provided to the market.

People ordinary skilled in the art will understand these and other objectives of the claimed invention after reading the following detailed description of the preferred embodiment, which is illustrated in the various figures and drawings.

### BRIEF DESCRIPTION OF DRAWINGS

FIG. 1 is a functional block diagram of a multi-language system according to the related art.

FIG. 2 is a flowchart describing the steps for displaying font files of natural languages on the user interface with the multi-language system shown in FIG. 1.

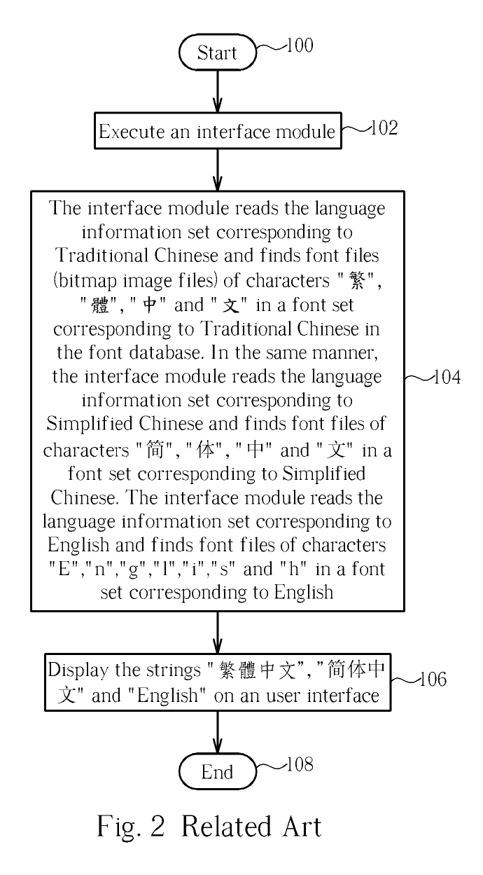

FIG. 3 is a functional block diagram of a multi-language system according to the present invention.

FIG. 4 is a flowchart describing the steps for displaying font files of natural languages on the user interface with the multi-language system shown in FIG. 3.

### DETAILED DESCRIPTION

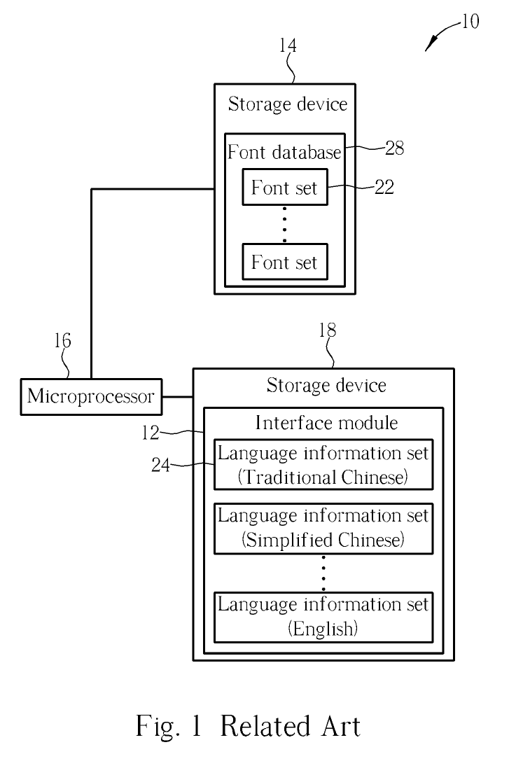

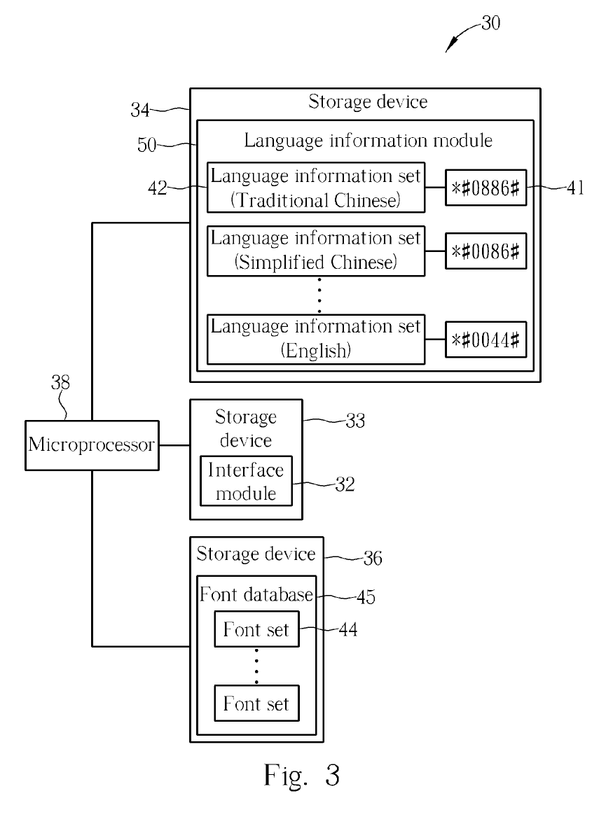

Please refer to FIG. 3. FIG. 3 is a functional block diagram of a multi-language system 30 according to the present invention. The multi-language system 30 comprises a microprocessor 38, an interface module 32, a language information module 50 and a font database 45. The interface module 32 is stored in a storage device 33, which is a Man-Machine Interface (MMI) software utilized for generating a user interface (MMI interface). The language information module 50 is stored in a storage device 34. The language information module 50 comprises a plurality of identification strings 41 and a plurality of language information sets 42. Each identification string 41 corresponds to a language information set 42, and each language information set 42 represents a natural language and is utilized for recording the related information to the natural language. The font database 45 is stored in a storage device 36. The font database 45 comprises a plurality of font sets 44. Each font set 44 corresponds to a language information set 42 and contains at least one font file (a bitmap image file corresponding to a character) for representing a natural language corresponding to the language information set 42. The microprocessor 38 is electrically connected to the storage device 33, the storage device 34 and the storage device 36. Please note that the elements in FIG. 3 have the same functions as those having the same names in FIG. 1. Therefore those functions are not depicted repeatedly.

Please refer to FIG. 3. The language information module 50 is independently installed outside of the interface module 32. As mentioned above, the language information module 50 is utilized for recording the related information corresponding to the natural languages supported in the multi-language system 30. For each natural language, the language information module 50 records the corresponding identification string 41 and the corresponding language information set 42. In other words, if the multi-language system 30 supports N natural languages (N kinds of natural languages), the language information module 50 records the N identification strings 41 and the N language information sets 42 respectively corresponding to the N natural languages.

In the present embodiment, the multi-language system 30 and the related method for updating language information are applied in a mobile unit, such as a mobile phone which conforms to the global system for mobile communications (GSM) specification. Besides, in the present embodiment, a supplementary service control string (SSC string) is utilized to be an identification string 41 utilized for corresponding to a language information set 42 of a specific natural language. For example, the identification string 41 representing Traditional Chinese is *#0886# which corresponds to the language information set 42 of Traditional Chinese. The identification string 41 *#0086# corresponds to the language information set 42 of Simplified Chinese. The identification string 41 *#0044# corresponds to the language information set 42 of English. SSC strings are defined in the GSM specification, wherein *#0886# represents Traditional Chinese, *#0086# represents Simplified Chinese, and *#0044# represents English. Therefore, manufacturers cannot redefine SSC strings. In the present invention, SSC strings are respectively utilized for representing language information sets 42 of different natural languages. Hence, the language information sets 42 corresponding to different natural languages supported in the multi-language system 30 are modulized to form the language information module 50, such that the interface module 32 can read the language information sets 42 corresponding to different natural languages by reading the SSC strings stored in the language information module 50. In the present embodiment, the language information module 50 is a configuration file.

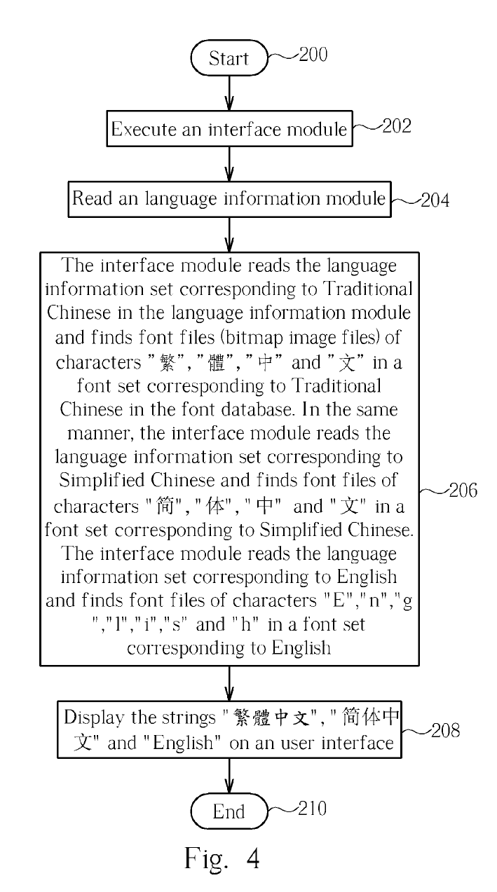

Please refer to FIG. 4. FIG. 4 is a flowchart describing the steps for displaying font files of natural languages on the user interface with the multi-language system 30. The displayed strings [symbol] [symbol] and “English” are given as examples for describing the steps for displaying font files of natural languages with the multi-language system 30. The steps are,

Step 200: Start;

Step 202: The microprocessor 38 executes the interface module 32;

Step 204: The interface module 32 reads the language information module 50 stored in the storage device 34;

Step 206: The interface module 32 reads the language information set 42 corresponding to Traditional Chinese in the language information module 50 and finds font files (bitmap image files) of characters [symbol] and [symbol] in a font set 44 corresponding to Traditional Chinese in the font database 45. In the same manner, the interface module 32 reads the language information set 42 corresponding to Simplified Chinese and finds font files of characters [symbol] and [symbol] in a font set 44 corresponding to Simplified Chinese. The interface module 32 reads the language information set 42 corresponding to English and finds font files of characters “E”, “n”, “g”, “l”, “i”, “s” and “h” in a font set 44 corresponding to English;

Step 208: Display the strings [symbol] [symbol] and “English” on the user interface; and

Step 210: End.

When a user turns on a mobile phone, the multi-language system 30 starts operating (step 200). Next, the microprocessor 38 loads the interface module 32 and executes it (step 202). The interface module 32 reads the language information module 50 stored in the storage device 34 to know the natural languages presently supported in the multi-language system 30 (step 204). As mentioned above, in the present embodiment, SSC strings are utilized to be identification strings 41 corresponding to the natural languages presently supported in the multi-language system 30. For example, *#0886# corresponds to Traditional Chinese, *#0086# corresponds to Simplified Chinese, and *#0044# corresponds to English. When the interface module 32 reads *#0886#, *#0086# and *#0044#, it knows that the mobile phone (the multi-language system 30) can support three natural languages, Traditional Chinese, Simplified Chinese and English.

Afterwards, in the step 206, the interface module 32 reads the language information set 42 corresponding to Traditional Chinese stored in the language information module 50 and finds font files (bitmap image files) of characters [symbol] and [symbol] in a font set 44 corresponding to Traditional Chinese in the font database 45. In the same manner, the interface module 32 reads the language information set 42 corresponding to Simplified Chinese stored in the language information module 50 and finds font files of characters [symbol] and [symbol] in a font set 44 corresponding to Simplified Chinese in the font database 45. The interface module 32 reads the language information set 42 corresponding to English stored in the language information module 50 and finds font files of characters “E”, “n”, “g”, “l”, “i”, “s” and “h” in a font set 44 corresponding to English in the font database 45. In the step 208, the interface module 32 displays the strings [symbol] [symbol] and “English” on the user interface to provide an environment of a multi-language interface for supporting and displaying Traditional Chinese, Simplified Chinese and English.

Please note that in the present embodiment, the multi-language system 30 is applied in a mobile phone. However, the multi-language system 30 is not limited to be applied in mobile phones, which means that the multi-language system 30 according to the present invention can be applied in any electronic devices that need to display various natural languages.

As mentioned above, each element in the multi-language system 30 communicates with each other using SSC strings. Hence, when a manufacturer needs to modify (eg: add or delete) a natural language supported in the multi-language system 30, it is only necessary to modify the language information module 50 and the font database 45, and the interface module 32 does not need to be modified. For example, when the multi-language system 30 needs to support Thai, a mobile phone manufacturer just needs to insert font set(s) 44 corresponding to Thai into the font database 45 stored in the storage device 36 and insert a SSC string (*#0066#) and a language information set 42 corresponding to Thai into the language information module 50 stored in the storage device 34. Therefore, after the interface module 32 reads *#0066#, the interface module 32 knows that the cell phone (which installs the multi-language system 30) supports Thai (supports displaying Thai). Next, the interface module 32 reads the language information set 42 corresponding to *#0066# (Thai) and finds needed font files in a font set 44 corresponding to Thai in the font database 45.

Assuming the present multi-language system 30 supports Traditional Chinese, Simplified Chinese, English and Thai, on account of the modification of market plan, assume a manufacturer wants to delete Simplified Chinese from the multi-language system 30. It is only necessary to delete font set(s) 44 corresponding to Simplified Chinese in the font database 45 stored in the storage device 36 and delete a SSC string *#0086# and a language information set 42 corresponding to Simplified Chinese in the language information module 50 stored in the storage device 34.

In summary, when a manufacturer wants to insert or delete a natural language into or from the multi-language system 30, without modifying the interface module 32 and the user interface provided by it (a MMI), a manufacturerjust needs to adjust the contents of the language information module 50 and the font database 45 to easily insert or delete a natural language into or from the multi-language system 30.

Compared with the related art, the language information sets corresponding to the various natural languages are modulized into a language information module by applying SSC strings in the multi-language system according to the present invention. The language information module is a configuration file. Therefore, the multi-language system contains the interface module, the language information module and the font database according to the present invention, wherein the interface module, the language information module and the font database can be stored in different storage devices. In another condition, the language information module and the font database are stored in a storage device and the interface module is stored in another storage device. In the two above-mentioned conditions, the language information module and the interface module are independent, which is the desired goal. When a manufacturer wants to insert or delete a specific natural language into or from the multi-language system according to the present invention, the manufacturer only needs to insert or delete an identification string and a language information set corresponding to the specific natural language into or from the language information module and insert or delete font set(s) corresponding to the specific natural language into or from the font database. Hence, the interface module does not need to be modified, which means the source code of the original interface module does not need to be modified and re-compiled to generate the needed interface module. Therefore, in a situation wherein the language information module and the interface module are independent, products (eg: a mobile phone) which apply the multi-language system according to the present invention are easily customized, which means it is easy and convenient to insert or delete a natural language into or from the above-mentioned products according to market needs. Hence, the products of different natural languages can be quickly provided to the market to increase the competitiveness.

Those skilled in the art will readily observe that numerous modifications and alterations of the device may be made while retaining the teachings of the invention. Accordingly, the above disclosure should be construed as limited only by the metes and bounds of the appended claims.

1. A multi-language system, comprising:
an interface module utilized for generating a user interface;
a language information module comprising at least one identification string and at least one language information set, each identification string corresponding to a language information set, and each language information set representing a natural language; and
a font database containing at least one font set, each font set corresponding to a language information set and containing at least one font file for representing the natural language corresponding to the language information set;
wherein according to the language information set stored in the language information module, the interface module is utilized for reading the font set corresponding to the natural language which corresponds to the language information set to select and display the font file(s) on the user interface.

2. The multi-language system of claim 1, wherein the identification string is a supplementary service control string (SSC string).

3. The multi-language system of claim 1 being applied in a mobile unit.

4. The multi-language system of claim 3, wherein the mobile unit conforms to the global system for mobile communications (GSM) specification.

5. The multi-language system of claim 1, wherein the language information module is a configuration file.

6. The multi-language system of claim 1, wherein when inserting or deleting a specific natural language into or from the multi-language system, an identification string and a language information set corresponding to the specific natural language are inserted into or deleted from the language information module, and the font set(s) corresponding to the specific natural language is (are) inserted into or deleted from the font database.

7. The multi-language system of claim 1, wherein the interface module is stored in a first storage device, and the language information module and the font database are stored in a second storage device.

8. The multi-language system of claim 1, wherein the interface module is stored in a first storage device, the language information module is stored in a second storage device, and the font database is stored in a third storage device.

9. The multi-language system of claim 1, wherein the user interface is a Man-Machine Interface (MMI).

10. A method for displaying multi languages on a user interface, comprising:
executing an interface module for generating a user interface;
reading a language information module, wherein the language information module comprises at least one identification string and at least one language information set, each identification string corresponding to a language information set, and each language information set representing a natural language;
finding a font file of a character stored in a font set corresponding to a specific natural language in the font database according to a language information set stored in the language information module, wherein the language information set corresponds to the specific natural language; and
displaying the font file on the user interface.

11. The method of claim 10, wherein the identification string is a supplementary service control string (SSC string).

12. The method of claim 10 being applied in a mobile unit.

13. The method of claim 12, wherein the mobile unit conforms to the global system for mobile communications (GSM) specification.

14. The method of claim 10, wherein the language information module is a configuration file.

15. The method of claim 10, wherein the interface module is stored in a first storage device, and the language information module and the font database are stored in a second storage device.

16. The method of claim 10, wherein the interface module is stored in a first storage device, the language information module is stored in a second storage device, and the font database is stored in a third storage device.

17. The method of claim 10, wherein the user interface is a Man-Machine Interface (MMI).

18. A method for inserting a specific natural language into the multi-language system, wherein the multi-language system comprises:
a language information module comprising at least one identification string and at least one language information set, each identification string corresponding to a language information set, and each language information set representing a natural language; and
a font database containing at least one font set, each font set corresponding to a language information set;
the method comprises:
inserting an identification string and a language information set corresponding to the specific natural language into the language information module; and
inserting the font set(s) corresponding to the specific natural language into the font database.

19. The method of claim 18, wherein the identification string is a supplementary service control string (SSC string).

20. The method of claim 18, wherein the language information module is a configuration file.

21. A method for deleting a specific natural language from the multi-language system, wherein the multi-language system comprises:
a language information module comprising at least one identification string and at least one language information set, each identification string corresponding to a language information set, and each language information set representing a natural language; and
a font database containing at least one font set, each font set corresponding to a language information set;
the method comprises:
deleting an identification string and a language information set corresponding to the specific natural language from the language information module; and
deleting the font set(s) corresponding to the specific natural language from the font database.

22. The method of claim 21, wherein the identification string is a supplementary service control string (SSC string).

23. The method of claim 21, wherein the language information module is a configuration file.
